(19) United States
(12) Patent Application Publication
(10) Pub. No.: US 2015/0375599 A1
(43) Pub. Date: Dec. 31, 2015

(54) AUTOMOBILE COOLING SYSTEM

(71) Applicant: Charles Esposito, Hasbrouck Heights, NJ (US)

(72) Inventor: Charles Esposito, Hasbrouck Heights, NJ (US)

(21) Appl. No.: 14/585,747

(22) Filed: Dec. 30, 2014

Related U.S. Application Data
(60) Provisional application No. 62/019,132, filed on Jun. 30, 2014.

(51) Int. Cl. B60H 1/00

(52) U.S. Cl. CPC B60H 1/00735

(57) ABSTRACT

A system and method for an automobile cooling system to alleviate high temperatures within a vehicle. The system includes a temperature sensor, which signals a control center when a preset temperature has been reached within the vehicle and an occupant sensor which signals the control center when an occupant is detected within the vehicle. Further, a fan system to circulate air within the vehicle, a window operating system for opening one or more of the vehicle's windows, an alert signal system for emitting an alert, and a signal initiating system to contact emergency personnel or subscribers to an automobile cooling system program when a preset temperature has been reached within the vehicle. Finally, the control center adapted to send signals to the fan system, the window operating system, the alert signal system, and the signal initiating system when the preset temperature has been reached within the vehicle.

This non-provisional application claims the benefit of the provisional application filed with the United States Patent and Trademark Office as Application No. 62/019,132 entitled AUTOMOBILE CEILING FAN, filed Jun. 30, 2014.

### TECHNICAL FIELD OF THE INVENTION

The present invention relates to an automobile cooling system for and more particularly to a system and method for alleviating high temperatures within a vehicle.

### BACKGROUND OF THE INVENTION

The loss of life to infants and children naturally captures national attention. Every year, a considerable and troubling number of infants, children and pets are injured and/or die due to heat related trauma (heat stroke or hyperthermia). Infants, small children and pets are intentionally or unintentionally left, or become trapped by playing, inside the passenger compartment of a family automobile and suffer from heat exposure. A child's body temperature increases three to five times faster than an adult's and children are not able to dissipate heat as efficiently as adults. In many occurrences, the children are strapped into infant seats, are secured by seat belts and/or are told by the driver to remain in the car. Still others are children who enter unlocked cars as part of play. They may lock themselves in, are too young or lack the developmental capability to reopen the car doors. Or they become disoriented and weak from the rapidly rising heat. In short, any unlocked car can become a deadly playground for small children.

The problem of entrapment and heat death is not confined to the young, but also occurs with older, handicapped, disoriented or infirm people who are being transported by others. The driver may leave the vehicle unattended for a period of time longer than expected, and the temperature rise in the vehicle may be so rapid that the handicapped or older person is effectively trapped in the vehicle and succumbs to hyperthermia or heat induced suffocation. Likewise, many pets or other animals left in locked vehicles die from hyperthermia. Just as with people, heat stroke in pets can cause nausea, loss of consciousness, irreparable brain damage, and death. Pets, more so than humans, are susceptible to overheating. Dogs, for example, are designed to conserve heat. Their sweat glands, which exist on their nose and the pads of their feet, are inadequate for cooling during hot days.

### SUMMARY OF THE INVENTION

According to an embodiment of the present invention, there is disclosed an automobile cooling system to alleviate high temperatures within a vehicle. The system includes a temperature sensor, which signals a control center when a preset temperature has been reached within the vehicle and an occupant sensor which signals the control center when an occupant is detected within the vehicle. Further, the system includes a fan system to circulate air within the vehicle, a window operating system for opening one or more of the vehicle's windows, an alert signal system for emitting an alert from the vehicle, and a signal initiating system to contact emergency personnel or subscribers to an automobile cooling system program when a preset temperature has been reached within the vehicle. Finally, the system includes the control center adapted to send signals to the fan system, the window operating system, the alert signal system, and the signal initiating system when the preset temperature has been reached within the vehicle.

According to another embodiment of the present invention, there is disclosed a method to alleviate high temperatures within a vehicle. The method includes signaling a control center when a preset temperature has been reached within the vehicle and signaling the control center when an occupant is detected within the vehicle. The method further includes circulating air within the vehicle, opening one or more of the vehicle's windows, emitting an alert from the vehicle, and contacting emergency personnel or subscribers to an automobile cooling system program when a preset temperature has been reached within the vehicle. Finally, the system includes sending signals to the fan system, the window operating system, and the signal initiating system when the preset temperature has been reached within the vehicle.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic view of the automobile cooling system, in accordance with the present invention.

FIG. 2 is a three-dimensional view of the automobile cooling system in use within a vehicle, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

Vehicles exposed to full sun in the summer experience extremely rapid rises of interior temperature. While there is some difference between a light colored vehicle and a dark colored vehicle, the difference is relatively insignificant from the point of view of the onset of hyperthermia. Interior temperatures of a closed vehicle can easily reach approximately 200°-250° F. Heat prostration and/or disorientation or incapacitation can occur within a few minutes under such conditions, and it is estimated that suffocation follows within half an hour to an hour. The automobile cooling system 10 is designed to reduce the temperature in the vehicle to prevent the onset of hyperthermia and heat induced suffocation. It is also within the terms of the embodiment that the automobile cooling system 10 incorporates a notification system to alert others about the temperature within the vehicle.

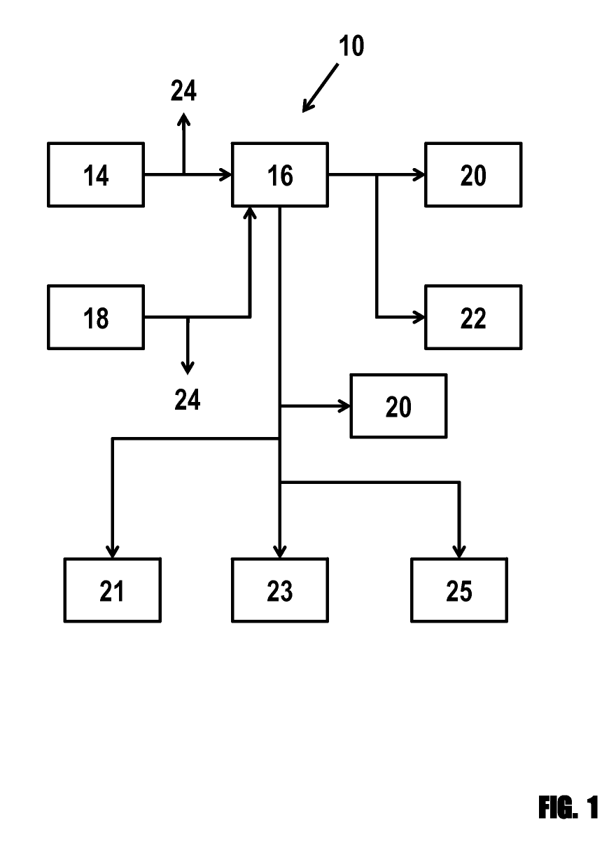

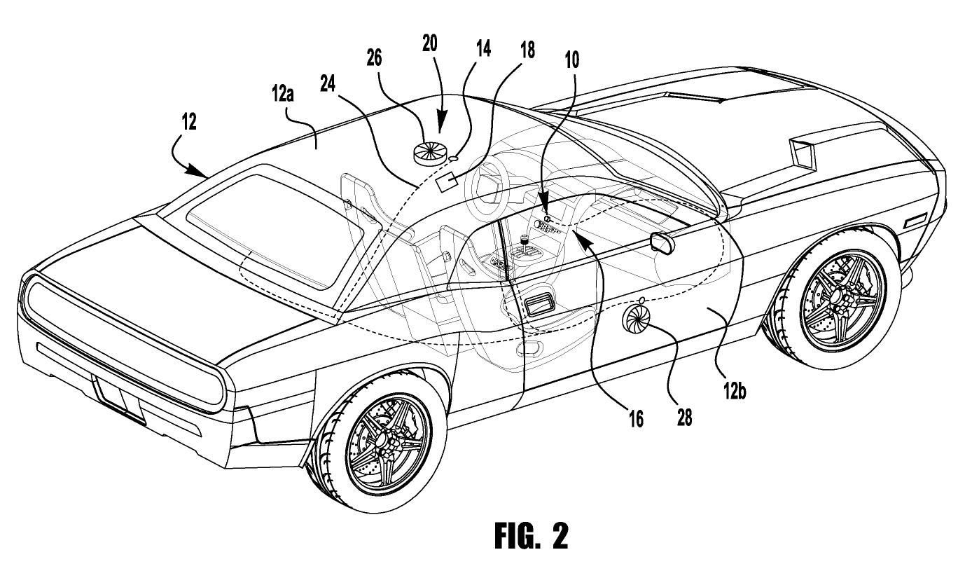

FIG. 1 illustrates a schematic view of the automobile cooling system 10, specifically designed to alleviate issues associated with high temperatures within a vehicle 12, as seen in FIG. 2. The automobile cooling system 10 functions to circulate air within the vehicle 12 when a preset temperature has been reached. In general terms, the cooling system 10 incorporates a temperature sensor 14, which notifies a control center 16, mounted within the vehicle 12 when a preset temperature has been reached within the vehicle. Preferably, an occupant sensor 18 will be incorporated within the vehicle to signal the control center 16 when an occupant is detected within the vehicle 12. In response to the temperature sensor 14 notifying the control center 16 that the preset temperature has been reached, the control center 16 will send a series of signals to alleviate the potentially hazardous temperature conditions within the vehicle. The control center 16 will signal a fan system 20 to initiate operations that provide air circulation from a central location within the vehicle. Also, the control center 16 will signal a window operating system 21 to power one or more of the car windows 22 to open in order to lower the temperature within the vehicle, by permitting cooler outside air to circulate within the vehicle. The control center 16 will signal an alert signal system 23 to alert passers-by or emergency personnel when one or more passengers are trapped in the vehicle 12. Finally, the control center 16 will signal a signal initiating system 25 to contact emergency personnel or subscribers when the preset temperature has been reached within the vehicle 12.

FIG. 2 illustrates a view of the vehicle 12 which incorporates the automobile cooling system 10. The control center 16 of cooling system 10 is disposed within the vehicle 12, preferably located underneath the dashboard. Wires 24 connect the control center 16 to the temperature sensor 14. Any type of desired temperature sensor 14 may be utilized, including but not limited to thermocouples, thermistors resistance-temperature detectors, and IC-temperature sensors.

Typically, the temperature sensor 14 transmits a signal to the control center 16 that a predetermined temperature has been detected. The predetermined temperature can include an upper limit of a high temperature (i.e., too hot to be comfortable and safe for an occupant), a lower limit of a low temperature (i.e., too cold to be comfortable and safe for an occupant). The predetermined temperature can include all temperatures hotter than the upper limit of a high/hot temperature, and all temperatures colder than the lower limit of a low/cold temperature. It is to be appreciated that a predetermined temperature as described herein may include one or more of the aforementioned temperatures. For example, a predetermined temperature may include all temperatures at 62 degrees Fahrenheit and lower, and at 75 degrees Fahrenheit and higher.

Preferably, an occupant sensor 18 will be incorporated to transmit a signal the control center 16, such as through wires 24, whenever an occupant is detected within the vehicle 12. A variety of sensors can be utilized for the occupant sensor 18. For example, a pressure sensor can be utilized to detect the presence of an occupant seated in a seat. A motion detector can be utilized to detect motion from an occupant. A CO₂ sensor can be utilized to detect the breath from an occupant. Other occupant sensors 16 include a passive infrared sensor and a charged particle heart rate sensor that utilizes centimeter wavelength microwaves to observe moving charges associated with the heart and respiration through detected microwave reflected energy. Further, the occupant sensor 18 can be set to detect the presence, the absence, or both the presence and the absence of an occupant, depending on the necessary input to the control center 16.

While wires 24 can connect the control center 16 to the temperature sensor 14 and the occupant sensor 18, it is also within the terms of the invention for the temperature sensor 14 and the occupant sensor 18 to interact with the control center wirelessly. The control center 16 can receive a signal from either or both of the temperature sensor 14 and the occupant sensor 18. However, it is within the terms of the preferred embodiment that the control center 16 only responds to the temperature sensor 14 if it also receives a signal from the occupant sensor 18 that one or more occupants are within the vehicle 12. In other words, the control center 16 only initiates a series of signals to alleviate a potentially hazardous temperature situation when, within a predetermined time period, the occupant sensor 18 detects the presence of an occupant and temperature sensor 14 detects a predetermined temperature.

The control center 16 typically incorporates a microprocessor, which is programmable and is set by the user. The user may control the settings of the automobile cooling system 10 through the microprocessor of the control center 16. The microprocessor may be programmed to set the predetermined temperatures, the occupant sensor 18 settings, various alarm settings, and any other desired settings, further described hereinafter. The microprocessor of the control center 16 is programmed to both receive the alerts from the temperature sensor 14 and the occupant sensor 18, and to initiate the signals to alleviate a potentially hazardous temperature within the vehicle 12.

The control center 16 is connected to the vehicle battery through the vehicle electrical system so that the cooling system 10 has power at all times. It is within the terms of the embodiment that a separate battery pack be used, both as an automatic back-up during periods of low vehicle battery power or to energize the automobile cooling system 10 totally.

The automobile cooling system 10 incorporates a fan system 20, which is designed to cool the vehicle 12 when a signal is initiated by the control center 16. The control center 16 will send a signal to the fan system 20, causing one or more fans to power on and begin cooling the interior of the vehicle 12. The speed of the fans and the duration of its use may be regulated by the user.

Typically, the fan system 20 includes a fan 26 that is located on the interior of the roof 12a of the vehicle 12 or a fan 28 located on the interior of the door 12b of the vehicle. Any desired form of fan 26 and/or 28 may be incorporated into the fan system 20 of the automobile cooling system 10. The following is an exemplary fan system 20. The fan 26 or 28 includes a back shell having an outer side adapted to mount to the interior of the roof 12a or the door 12b and an inner side, respectively, having at least one stud attached thereto. A wing nut attachment is connected to the at least one stud extending outward from the back shell. The wing nut attachment may have an opening in the center where a fan may be placed. The fan may consist of a plurality of fan blades and a motor. The motor of the fan may be placed within the opening in the wing nut attachment. A cover plate may be placed over the fan so that the fan blades may be enclosed between the back shell and the cover plate. The cover plate may have openings so that when the fan is in motion, the air flows through the openings. The cover plate may attach to the back shell by snapping into position. It is within the terms of the embodiment that there be lights attached to the fan blades to alert passerby's and emergency responders about the hazardous temperature within the vehicle.

The control center 16 will further send a signal a window operating system 21 to open one or more of the car windows 22 in order to lower the temperature within the vehicle 12, by permitting cooler outside air to circulate within the vehicle. Typically, a window opening device will be incorporated into one or more of the windows 22 of the vehicle 12. Upon receiving a signal from the control center 16, the device 46 will cause the window 22 to lower, thereby reducing the heat within the vehicle 12 and allowing air to circulate therein.

The control center 16 will signal an alert signal system 23 to initiate a variety of alerting signals to passerbys and emergency personnel of the hazardous temperature conditions within the vehicle 12. These signals may include triggering an audible alarm from a speaker, or flashing a light from within the vehicle 12. Further, the signal from the control center 16 can cause door 12b to unlock. It is also within the terms of the invention for the control center 16 to send signals to initiate other functions in the vehicle.

The control center 16 may incorporate a first temperature alert application software embedded in the microprocessor associated therewith. A subscriber may interact with the first temperature alert application software with a second temperature alert application software within the subscriber's mobile communications device, such as a smart phone. The temperature alert application software operates as a mobile application for smartphones and tablet devices and is installed into the smartphones or other mobile communications devices of each of the subscribers. After downloading the temperature alert application, the subscriber creates an account on a data server machine through the alert application including contact information, credit card information, and any other relevant information. After creating this account and authorizing payment, the subscriber 12 becomes a “member” of the automobile cooling system 10 for a specific vehicle 12.

The data server is a machine which may be a network-connected server computer system or set of computer systems that can be hosted by a web server or server farm. The data server machine contains a computer including a processor, non-transitory memory, a hard disk, a standard application interface (API) and a database stored thereon. The database resides on the hard disk. The database can be continually updated by a synchronization function of the API which manages access to the database. The database is able to manage multiple concurrent access to and from the data server. Further, the data server has the ability to print out information to allow a hard copy to be sent to a subscriber. The data server provides subscription services to the subscribers whereby it receives and processes the subscriber's information and payment.

The control center 16 will signal a signal initiating system 25 to contact emergency personnel or subscribers to an automobile cooling system program when the preset temperature has been reached within the vehicle 12. As a subscriber to the automobile cooling system 10, the control center 16 can initiate a message, in response to the temperature sensor 14 and/or the occupant sensor 18, which is relayed to the data server machine. The data server machine may then initiate a call, email, text message, or any other desired form of communication to the subscriber about the temperature hazard within the vehicle 12. Further, the data server 14 may relay a message to the police or any other emergency personnel about the temperature hazard.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An automobile cooling system to alleviate high temperatures within a vehicle, comprising:
a temperature sensor, which signals a control center when a preset temperature has been reached within the vehicle;
an occupant sensor which signals the control center when an occupant is detected within the vehicle;
a fan system to circulate air within the vehicle;
a window operating system for opening one or more of the vehicle's windows;
an alert signal system for emitting an alert from the vehicle;
a signal initiating system to contact emergency personnel or subscribers to an automobile cooling system program when a preset temperature has been reached within the vehicle; and
the control center adapted to send signals to the fan system, the window operating system, the alert signal system, and the signal initiating system when the preset temperature has been reached within the vehicle.

2. The automobile cooling system of claim 1 wherein the control center of the automobile cooling system is mounted within the vehicle and is connected to the fan system, the window operating system, the alert signal system, and the signal initiating system. temperature sensor.

3. The automobile cooling system of claim 2 wherein the temperature sensor transmits a signal to the control center when a predetermined temperature between an upper limit of a high temperature and a lower limit of a low temperature has been detected.

4. The automobile cooling system of claim 3 wherein the occupant sensor is incorporated within the vehicle and transmits a signal to the control center whenever an occupant is detected within the vehicle.

5. The automobile cooling system of claim 4 wherein the temperature sensor and the occupant sensor transmit signals to the control center wirelessly.

6. The automobile cooling system of claim 1 wherein the control center sends signals to the fan system, the window operating system, and the signal initiating system when the occupant sensor signals that one or more occupants are within the vehicle.

7. The automobile cooling system of claim 1 wherein the control center incorporates a programmable microprocessor which is set by a user to control the settings of the automobile cooling system.

8. The automobile cooling system of claim 7 wherein the fan system includes one or more fans to power on and cool the vehicle's interior in response to a signal from the control center.

9. The automobile cooling system of claim 8 wherein a window operating system is associated with one or more of the vehicle's windows for lowering the one or more of the vehicle's windows in response to a signal from the control center.

10. The automobile cooling system of claim 7 wherein:
the control center incorporates a first temperature alert application software embedded in the programmable microprocessor; and
a second temperature alert application software within a subscriber's mobile communications device to enable the subscriber to communicate with the first temperature alert application software embedded in the programmable microprocessor.

11. An method to alleviate high temperatures within a vehicle, comprising:
signaling a control center when a preset temperature has been reached within the vehicle;
signaling the control center when an occupant is detected within the vehicle;
circulating air within the vehicle;
opening one or more of the vehicle's windows;
emitting an alert from the vehicle;
contacting emergency personnel or subscribers to an automobile cooling system program when a preset temperature has been reached within the vehicle; and
sending signals to the fan system, the window operating system, and the signal initiating system when the preset temperature has been reached within the vehicle.

12. The method of claim 11 further including mounting the control center of the automobile cooling system within the vehicle and connecting the control center to the fan system, the window operating system, the alert signal system, and the signal initiating system temperature sensor.

13. The method of claim 12 further including incorporating a temperature sensor within the vehicle and transmitting a signal to the control center when a predetermined temperature between an upper limit of a high temperature and a lower limit of a low temperature has been detected.

14. The method of claim 13 further including incorporating an occupant sensor within the vehicle and transmitting a signal to the control center whenever an occupant is detected within the vehicle.

15. The method of claim 14 further including transmitting signals to the control center wirelessly.

16. The method of claim 11 further including signaling the fan system, the window operating system, the alert signal system, and the signal initiating system when the occupant sensor signals that one or more occupants are within the vehicle.

17. The method of claim 11 incorporating a programmable microprocessor into the control center which is set by a user for controlling the settings of the automobile cooling system.

18. The method of claim 17 further including signaling one or more fans and powering the one or more fans on and cooling the vehicle's interior in response to a signal from the control center.

19. The method of claim 18 further including wherein associating a window operating system with one or more of the vehicle's windows for lowering the one or more of the vehicle's windows in response to a signal from the control center.

20. The method of claim 17 further including:
incorporating a first temperature alert application software embedded in the programmable microprocessor of the control center; and
enabling a subscriber to communicate with the first temperature alert application software embedded in the programmable microprocessor using a second temperature alert application software within the subscriber's mobile communications device.
